(19) United States
(12) Patent Application Publication
(10) Pub. No.: US 2015/0220151 A1
(43) Pub. Date: Aug. 6, 2015

(54) DYNAMICALLY CHANGE BETWEEN INPUT MODES BASED ON USER INPUT

(71) Applicants: Scott Ronald Violet, Sunnyvale, CA (US); Glen Murphy, Palo Alto, CA (US); Roma Rajni Shah, San Francisco, CA (US); John Nicholas Jitkoff, Palo Alto, CA (US)

(72) Inventors: Scott Ronald Violet, Sunnyvale, CA (US); Glen Murphy, Palo Alto, CA (US); Roma Rajni Shah, San Francisco, CA (US); John Nicholas Jitkoff, Palo Alto, CA (US)

(21) Appl. No.: 13/831,297

(22) Filed: Mar. 14, 2013

(51) Int. Cl. G06F 3/01

(52) U.S. Cl. CPC G06F 3/017

(57) ABSTRACT

A system and machine-implemented method for automatically changing between input modes based on user input includes receiving user input in association with a user interface element, the user input comprising an input type and an input gesture. A determination is made whether the input type is a first input type or a second input type. In a case where the input type is the first input type, a determination is made that the input gesture is a first predetermined gesture, and the user interface is switched from a second input mode to a first input mode. In a case where the input type is the second input type, a determination is made that the input gesture is a second predetermined gesture, and the user interface is switched from the first mode to the second mode.

### BACKGROUND

The present disclosure generally relates to user input and, in particular, to automatically changing between input modes based on user input.

User interfaces (UIs) can be optimized for signals of a particular input (e.g., mouse, touchscreen, stylus, etc.). For example, a tabstrip of a web browser UI may be optimized for the use of mouse input. Alternatively, the tabstrip may be optimized for the use of touch input.

### SUMMARY

The disclosed subject matter relates to a computer-implemented method for automatically changing between input modes based on user input. The method comprises receiving user input in association with a user interface element, the user input comprising an input type and an input gesture, and determining whether the input type is a first input type or a second input type. The method further comprises, in a case where the input type is the first input type, determining that the input gesture is a first predetermined gesture, and switching, in response to determining that the input gesture is the first predetermined gesture, the user interface from a second input mode to a first input mode. In addition, the method comprises, in a case where the input type is the second input type, determining that the input gesture is a second predetermined gesture, and switching, in response to determining that the input gesture is the second predetermined gesture, the user interface from the first mode to the second mode.

The disclosed subject matter further relates to a system for automatically changing between input modes for a user interface. The system comprises one or more processors, and a machine-readable medium comprising instructions stored therein, which when executed by the processors, cause the processors to perform operations comprising receiving user input in association with a user interface element of the user interface, the user input comprising an input type and an input gesture, and determining whether the input type is a first input type or a second input type. The operations further comprise, in a case where the input type is the first input type, determining that the input gesture is a first predetermined gesture, and switching, in response to determining that the input gesture is the first predetermined gesture, the user interface from a second input mode to a first input mode. In addition, the operations comprise, in a case where the input type is the second input type, determining that the input gesture is a second predetermined gesture, and switching, in response to determining that the input gesture is the second predetermined gesture, the user interface from the first mode to the second mode.

The disclosed subject matter also relates to a machine-readable medium comprising instructions stored therein, which when executed by a system, cause the system to perform operations comprising receiving user input in association with a user interface element, the user input comprising an input type and an input gesture. The operations further comprise determining that the input type is a first input type, and determining, in response to determining that the input type is the first input type, that the input gesture is a predetermined gesture. In addition, the operations comprise switching, in response to determining that the input gesture is the predetermined gesture, the user interface from a second input mode to a first input mode.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example network environment which can provide for automatically changing between input modes based on user input.

FIG. 2 illustrates an example of a tabbed interface displayed in a shrink mode, which is configured for a first input type.

FIG. 3 illustrates an example of a tabbed interface displayed in a stack mode, which is configured for a second input type.

FIGS. 4A-4B illustrate an example of a tabbed interface switching from a stack mode to a shrink mode in response to a gesture of the first input type.

FIGS. 5A-5B illustrate another example of a tabbed interface switching from a stack mode to a shrink mode in response to a gesture of the first input type.

FIGS. 6A-6B illustrate an example of a tabbed interface switching from a shrink mode to a stack mode in response to a gesture of the second input type.

FIG. 7 illustrates an example process by which input modes are automatically changed based on user input.

FIG. 8 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, user interfaces (UIs) are generally optimized for signals of a particular input (e.g., mouse, touchscreen, stylus, etc.). For example, a tabbed interface of a web browser UI may be optimized for using a mouse as an input device. Since a mouse provides more precise movement than alternate inputs such as a touchscreen, the tabbed interface in the web browser may shrink tabs corresponding to web pages that are not currently being viewed. Thus, if a user switches to a different input, such as a touchscreen, during the same session, the user may experience inconveniences in navigating on the web browser UI optimized for mouse use. While providing a settings function for toggling between different UIs may address this issue, having to manually change the settings may interrupt the user's workflow/fluidity. Thus, it may be desirable to implement a system that automatically changes between input modes of a UI based on certain user inputs.

The subject disclosure provides for automatically changing between input modes based on user input. User input is received in association with a user interface element (e.g., a tabbed interface of a web browser or other application). The user input includes an input type (e.g., mouse input or touch input) and an input gesture. In example aspects, the user interface element is configured to display in a first input mode for a first input type (e.g., for a tabbed interface, a shrink mode for mouse input) and in a second input mode for a second input type (e.g., a stack mode for touch input).

A determination is made whether the input type is the first input type or the second input type. In a case where the input type is the first input type (e.g., mouse input), a determination is made that the input gesture is a first predetermined gesture, and, in response to determining that the input gesture is the first predetermined gesture (e.g., mouse movement into and out of the tabbed interface, or a mouseclick selecting one tab from the one or more tabs of the tabbed interface), the user interface switches from the second input mode to the first input mode. In a case where the input type is the second input type (e.g., touch input), a determination is made that the input gesture is a second predetermined gesture (e.g., a touch input selecting one tab from the one or more tabs of the tabbed interface), and, in response to determining that the input gesture is the second predetermined gesture, the user interface switches from the first mode to the second mode.

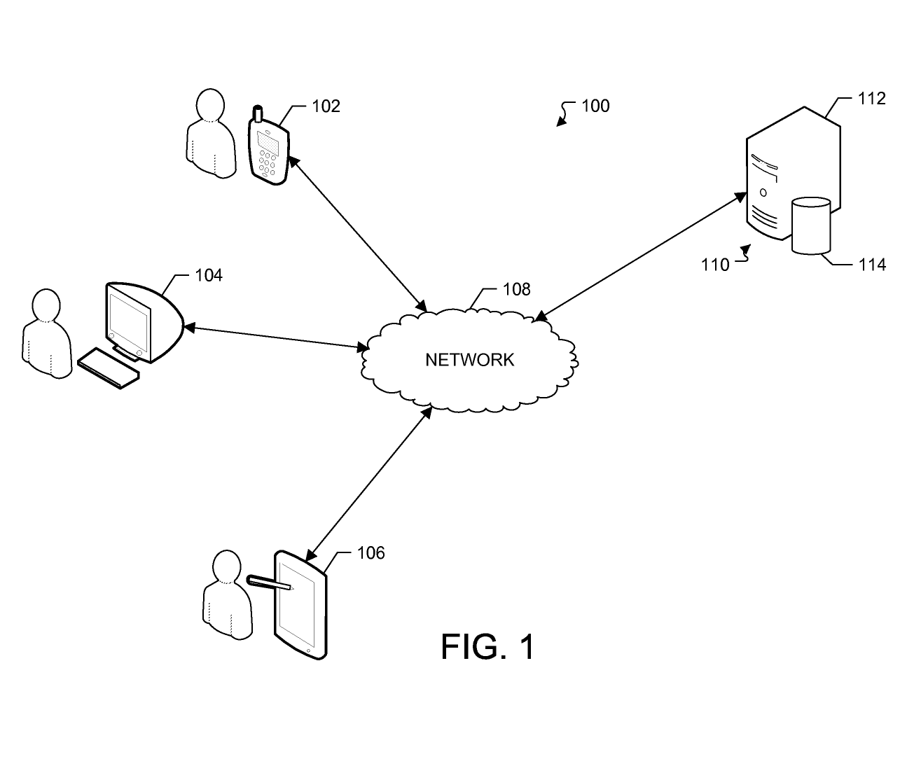

FIG. 1 illustrates an example network environment which can provide for automatically changing between input modes based on user input. A network environment 100 includes a number of electronic devices 102-106 communicably connected to a server 110 by a network 108. Each of electronic devices 102-106 can include a touchscreen, which can be built into the device itself or can be electronically connected to the device (e.g., as a peripheral device). Server 110 includes a processing device 112 and a data store 114. Processing device 112 executes computer instructions stored in data store 114, for example, to provide content (e.g., a website or other display content) to any of electronic devices 102-106.

Electronic devices 102-106 can be mobile devices (e.g., smartphones, tablet computers, PDAs, and laptop computers), portable media players, desktop computers or other appropriate computing devices. In the example of FIG. 1, electronic device 102 is depicted as a smartphone, electronic device 104 is depicted as a desktop computer, and electronic device 106 is depicted as a tablet computer.

In some example aspects, any of the electronic devices 102-106 may obtain application data (e.g., web page data), and content (e.g., images, video, text, links) corresponding to the application data can be displayed on a touchscreen of the electronic device (e.g., 102-106). In some example aspects, the content can be transmitted from server 110 via the network 108 to the electronic devices 102-106. In other example aspects, the content can be stored in a storage component (e.g., hard disk, RAM, ROM, etc.) of the respective electronic devices 102-106.

Any of electronic devices 102-106 can receive user input in association with a user interface element (e.g., a tabbed interface of a web browser or other application). The user input includes an input type (e.g., mouse or touch input) and an input gesture. In example aspects, the user interface element is configured to display in a first input mode for a first input type and in a second input mode for a second input type. The electronic device (e.g., any of 102-106) determines whether the input type is the first input type or the second input type. In a case where the input type is the first input type, the electronic device can determine that the input gesture is a first predetermined gesture, and switch, in response to determining that the input gesture is the first predetermined gesture, the user interface from the second input mode to the first input mode. In a case where the input type is the second input type, the electronic device can determine that the input gesture is a second predetermined gesture, and switch, in response to determining that the input gesture is the second predetermined gesture, the user interface from the first mode to the second mode.

Server 110 may be any system or device having a processor, a memory, and communications capability for providing content to the electronic devices. In some example aspects, server 110 can be a single computing device such as a computer server. In other embodiments, server 110 can represent more than one computing device working together to perform the actions of a server computer (e.g., cloud computing).

Network 108 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

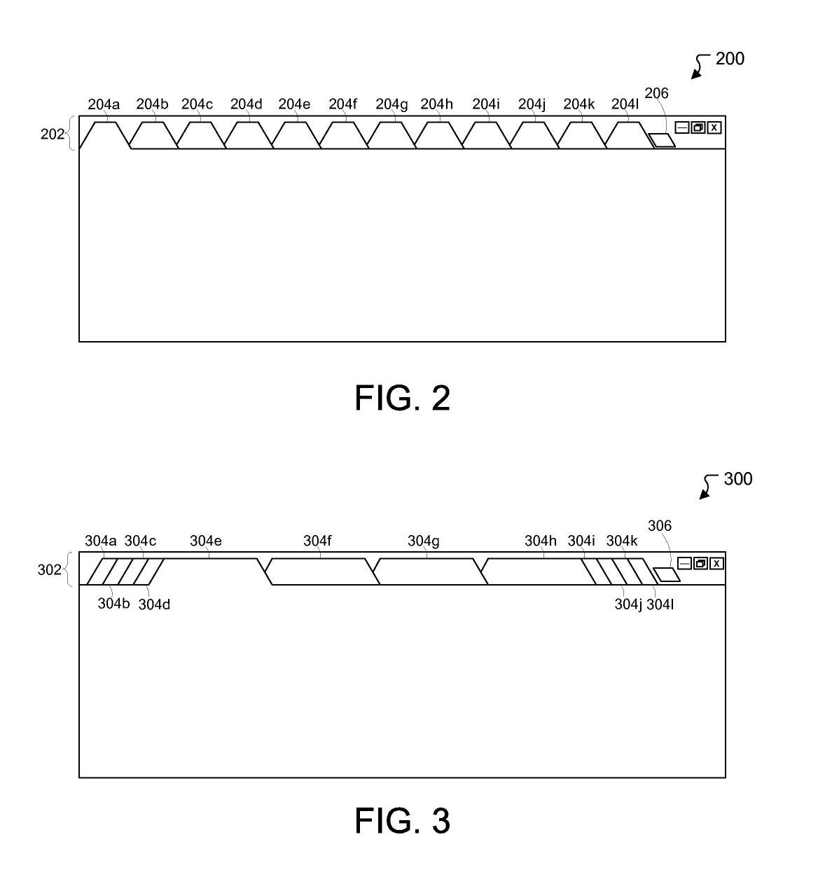

FIG. 2 illustrates an example of a tabbed interface displayed in a shrink mode, which is configured for a first input type. Application 200 includes a tabbed interface 202. Application 200 can correspond to any application which uses a tabbed interface including, but not limited to, a web browser or other web application, a text editor, a word processor, a software development kit or a preference pane.

Tabbed interface 202 allows multiple documents to be contained within a single window (e.g., within application 200), using tabs as a navigational widget for switching between different documents. In the example of FIG. 2., tabbed interface 202 includes tabs 204a-2041, where each of tabs 204a-2041 is associated with a different document (e.g., different web pages for a web browser). In example aspects, tabbed interface 202 is a tabstrip in which tabs 204a-2041 are displayed in a strip fashion. However, tabbed interface 202 is not limited to a tabstrip and other arrangements for tabs 204a-2041 can be used.

In tabbed interface 202, tabs 204a-2041 are displayed in a shrink mode. As used herein, “shrink mode” corresponds to its plain and ordinary meaning, including but not limited to a display mode for a tabbed interface in which tabs are continuously shrunk as new tabs are added. In example aspects, tabs displayed in the shrink mode correspond to a first input type, such as mouse, trackball, pen or stylus input. For example, since input via a mouse, trackball, pen or stylus can be more precise than touch input or trackpad input, the continuous shrinking of tabs may be manageable for a user. Display of tabs in the shrink mode can be compared to display of tabs in the stack mode, which is described in greater detail with reference to FIG. 3.

As seen in the example of FIG. 2, tabs 204a-2041 are generally equal in size. For example, the tabbed portion of tab 204a is approximately the same size as the tabbed portions for each of tabs 204b-2041. If a user adds a new tab using new tab interface 206, all of tabs 204a-2041 are shrunk. A new tab is added with a tabbed portion approximately equal in size to those for tabs 204a-2041, and the new tab can become the active tab.

FIG. 3 illustrates an example of a tabbed interface displayed in a stack mode, which is configured for a second input type. Application 300 includes a tabbed interface 302. Application 300 can correspond to any application which uses a tabbed interface including, but not limited to, a web browser or other web application, a text editor, a word processor, a software development kit or a preference pane.

Tabbed interface 302 allows multiple documents to be contained within a single window (e.g., within application 300), using tabs as a navigational widget for switching between different documents. In the example of FIG. 3., tabbed interface 302 includes tabs 304a-304l, where each of tabs 304a-304l is associated with a different document (e.g., different web pages for a web browser). In example aspects, tabbed interface 302 is a tabstrip in which tabs 304a-304l are displayed in a strip fashion. However, tabbed interface 302 is not limited to a tabstrip and other arrangements for tabs 304a-304l can be used.

In tabbed interface 302, tabs 304a-304l are displayed in a stack mode. As used herein, “stack mode” corresponds to its plain and ordinary meaning, including but not limited to a display mode for a tabbed interface in which tabs are continuously shrunk until reaching a preset size, and after reaching the preset size, one or more stacked regions of tabs are formed. In example aspects, tabs displayed in the stack mode correspond to a second input type, such as touch or trackpad input. For example, since input via touch or a trackpad may not be as precise as input via a mouse, trackball, pen or stylus, the use of stacked regions may be more manageable for a user.

In the example of FIG. 3, a first stacked region is formed for tabs 304a-304d, and a second stacked region is formed for tabs 304i-304l. In addition, tabs 304e-304h are not part of a stacked region and have tabbed portions which are approximately equal in size to each other. Further, if a user adds a new tab using new tab interface 306, the new tab becomes the active tab, and tabs 304a-304l can be arranged to include one or more stacked regions.

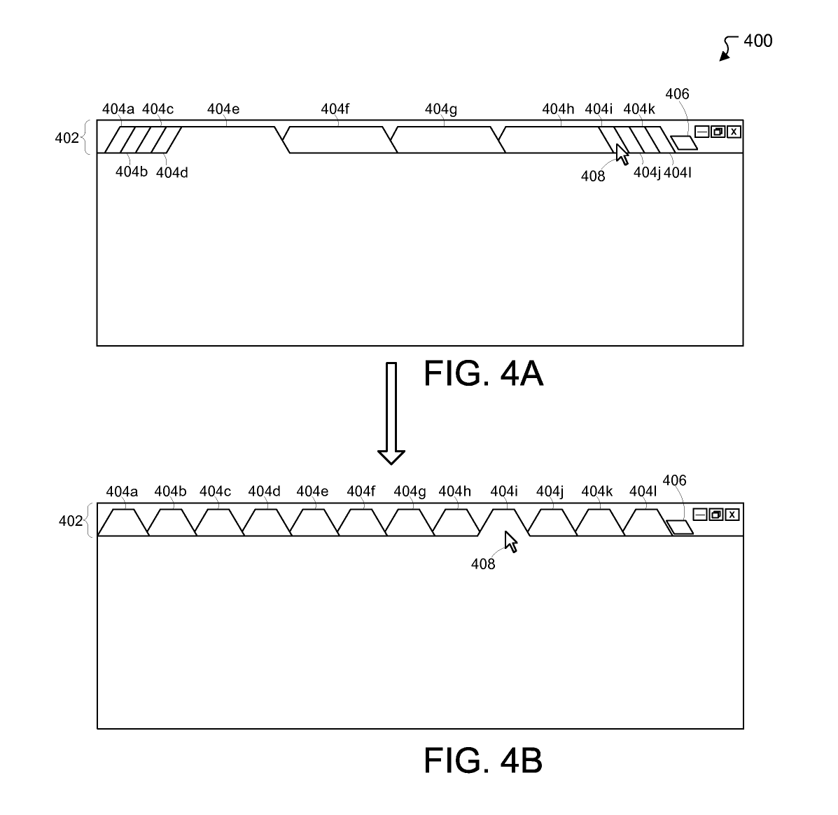

FIGS. 4A-4B illustrate an example of a tabbed interface switching from a stack mode to a shrink mode in response to a gesture of the first input type. The subject disclosure provides for switching between first and second input modes (e.g., the shrink mode for mouse, and the stack mode for touch input). In the example of FIGS. 4A-4B, tabbed interface 402 of application 400 switches from a stack mode to a shrink mode in response to a selection (e.g., mouseclick) of a tab within tabbed region 402.

For example, a user can move a cursor 408 (e.g., via mouse input) within tabbed interface 402, and can further select a tab within a stacked region. In the example of FIGS. 4A-4B, a first stacked region is formed for tabs 304a-304d and a second stacked region is formed for tabs 304i-304l. Further, the user selects tab 404i by moving cursor 408 to tab 404i and clicking on tab 404i.

In response to detecting the selection of tab 404i, tabbed interface 402 switches from the stack mode shown in FIG. 4A to the shrink mode shown in FIG. 4B. FIG. 4B further illustrates that in the shrink mode, the active tab is tab 404i, corresponding to the tab selected by the user via cursor 408 in FIG. 4A.

In example aspects, tabbed interface 402 switches from the stack mode to the shrink mode only in the case where cursor 408 selects a tab within a stacked region (e.g., within tabs 304a-304d or within 304i-304l). Alternatively, it is possible for tabbed interface 402 to switch from the stack mode to the shrink mode when any tab (e.g., any of tabs 304a-304l) is selected.

It should be noted that the selection of a tab within tabbed interface 402 is not limited to mouse input via cursor 408. In example aspects, the selection of a tab within tabbed interface 402 via mouse, trackball, pen or stylus can cause tabbed interface 402 to switch from the stack mode to the shrink mode.

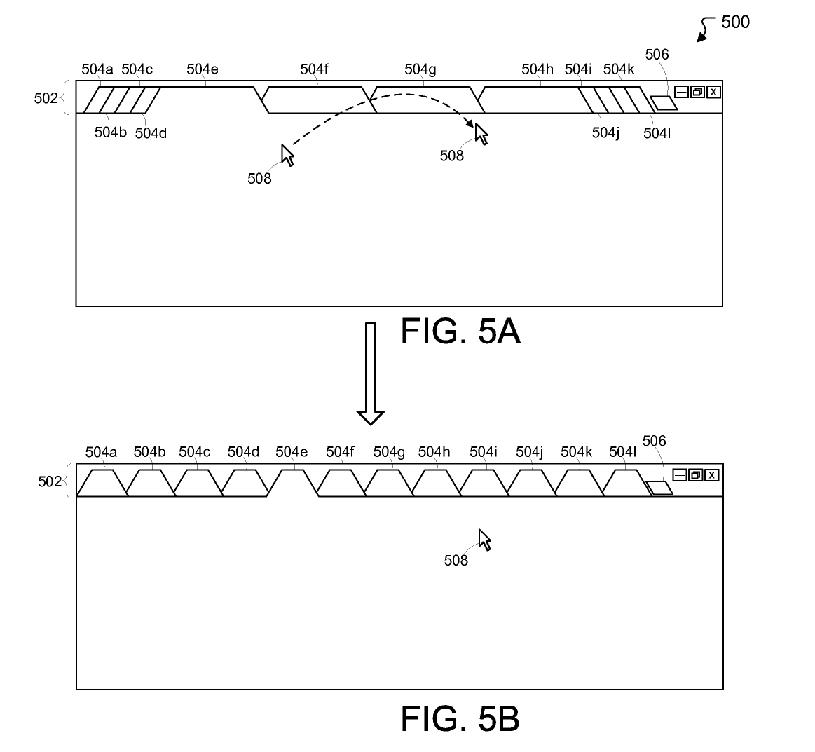

FIGS. 5A-5B illustrate another example of a tabbed interface switching from a stack mode to a shrink mode in response to a gesture of the first input type. The subject disclosure provides for switching between first and second input modes (e.g., the shrink mode for mouse, and the stack mode for touch input). In the example of FIGS. 5A-5B, tabbed interface 502 of application 500 switches from a stack mode to a shrink mode in response to movement (e.g., mouse movement) into and out of tabbed interface 502.

As seen by the dotted line in FIG. 5A, a user moves a cursor 508 (e.g., via mouse input) within tabbed interface 502 and subsequently out of tabbed interface 502. In response to this movement into and out of tabbed interface 502, tabbed interface 502 switches from the stack mode shown in FIG. 5A to the shrink mode shown in FIG. 5B. FIG. 5B further illustrates that in the shrink mode, the active tab is tab 504e, corresponding to the tab which was previously active in FIG. 5A, prior to switching from the stack mode to the shrink mode.

It should be noted that the movement into and subsequently out of tabbed interface 502 is not limited mouse input via cursor 508. In example aspects, such movement within tabbed interface 502 via mouse, trackball, pen or stylus can cause tabbed interface 502 to switch from the stack mode to the shrink mode.

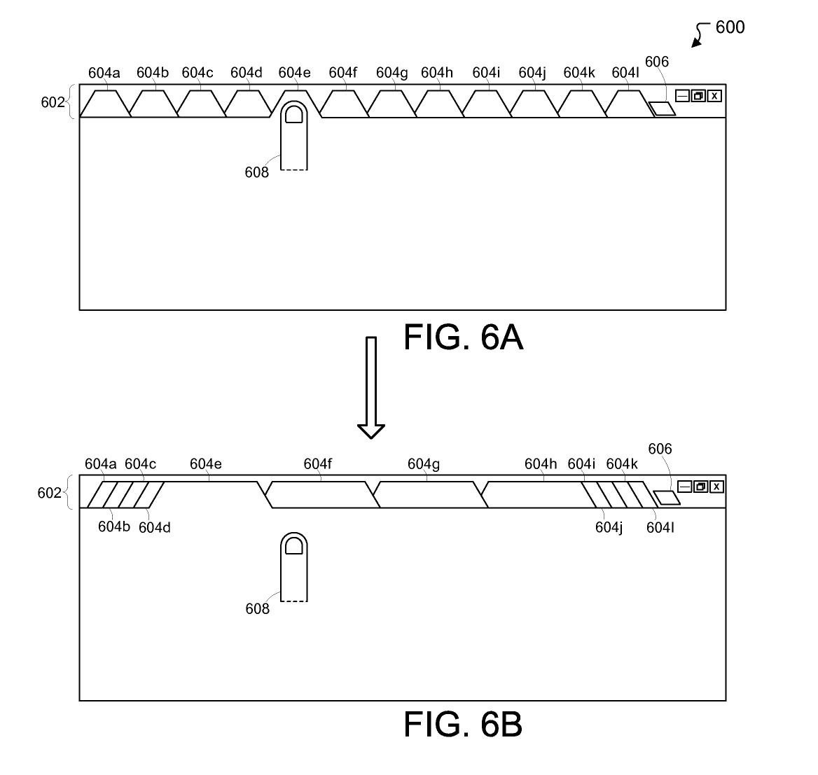

FIGS. 6A-6B illustrate an example of a tabbed interface switching from a shrink mode to a stack mode in response to a gesture of the second input type. FIGS. 6A-6B illustrate an example of a tabbed interface switching from a shrink mode to a stack mode in response to a gesture of a second input type. The subject disclosure provides for switching between first and second input modes (e.g., the stack mode for touch input, and the shrink mode for mouse input). In the example of FIGS. 6A-6B, tabbed interface 602 of application 600 switches from a shrink mode to a stack mode in response to a selection (e.g., touch input) of a tab within tabbed region 602.

For example, a user can use his/her finger 608 within tabbed interface 602, and can further select a tab in tab interface 602 via touch input. In response to detecting the selection of tab 604e, tabbed interface 602 switches from the shrink mode shown in FIG. 6A to the stack mode shown in FIG. 6B. FIG. 6B further illustrates that in the stack mode, the active tab is tab 604e, corresponding to the tab selected by the user via finger 408 in FIG. 6A.

It should be noted that the selection of a tab within tabbed interface 602 is not limited touch input (e.g., via finger 608). In example aspects, the selection of a tab within tabbed interface 602 via touch or trackpad input can cause tabbed interface 602 to switch from the shrink mode to the stack mode.

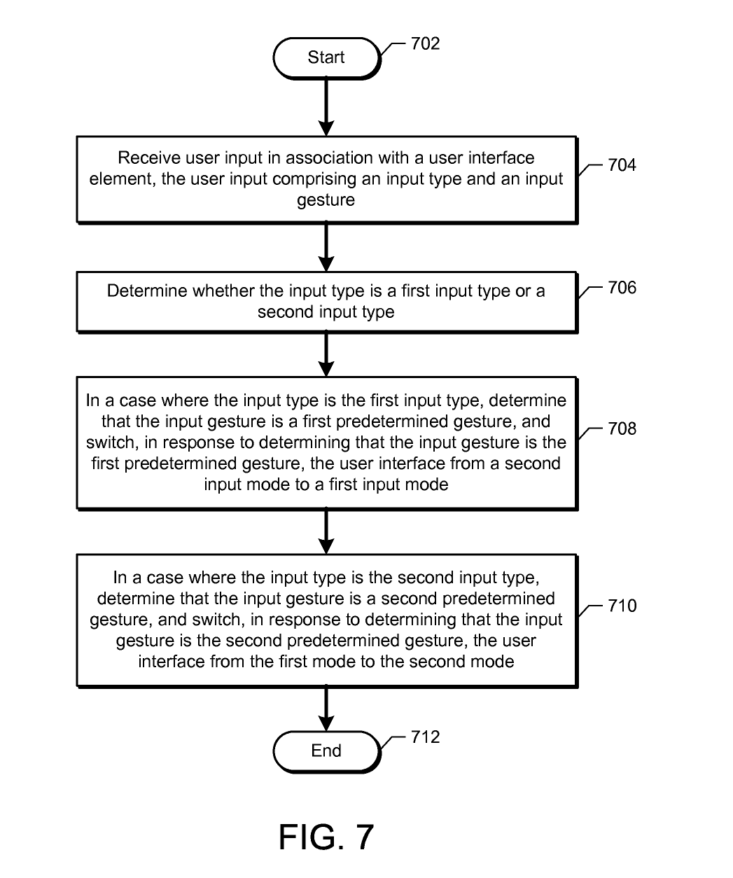

FIG. 7 illustrates an example process by which input modes are automatically changed based on user input. Following start block 702, user input is received in association with a user interface element at step 704. The user input comprises an input type and an input gesture. In example aspects, the user interface element is configured to display in a first input mode for a first input type and in a second input mode for a second input type. The user interface element can be a tabbed interface comprising one or more tabs.

At step 706, a determination is made whether the input type is the first input type or the second input type. The first input type can correspond to mouse input, trackball input, pen input or stylus input. The second input type can correspond to touch input or trackpad input.

At step 708, in a case where the input type is the first input type, a determination is made that the input gesture is a first predetermined gesture, and in response to determining that the input gesture is the first predetermined gesture, the user interface is switched from the second input mode to the first input mode.

In the example where the user interface element is the tabbed interface, the first predetermined gesture can be movement into and out of the tabbed interface. Alternatively, or in addition, the first predetermined gesture can be selection of one tab from the one or more tabs of the tabbed interface.

The first input mode can be a shrink mode, such that when new tabs are added to the tabbed interface, tabs of the tabbed interface are continuously shrunk. In addition, the second input mode can be a stack mode, such that when new tabs are added to the tabbed interface, tabs are continuously shrunk until reaching a preset size, and tabs are stacked after reaching the preset size.

At step 710, in a case where the input type is the second input type, a determination is made that the input gesture is a second predetermined gesture, and in response to determining that the input gesture is the second predetermined gesture, the user interface is switched from the first mode to the second mode. In the example where the user interface element is the tabbed interface, the second predetermined gesture can be selection of one tab from the one or more tabs of the tabbed interface. The process then ends at end block 712.

Although the foregoing examples describe switching of input modes as they relate to tabbed interfaces, the subject technology is not limited to tabbed interfaces. Rather, the subject technology can be employed for other user interface elements, such that the user interface elements adapt to one of multiple potential input types (e.g., mouse, trackball, pen, stylus, touch and/or trackpad input).

For example, a user interface element can switch from a touch-optimized mode to a mouse-optimized mode upon detection of a first predetermined gesture entered via mouse input. In another example, the user interface element can switch from a mouse-optimized mode to a touch-optimized mode upon detection of a second predetermined gesture (e.g., which can be similar or different than the first predetermined gesture) entered via touch input.

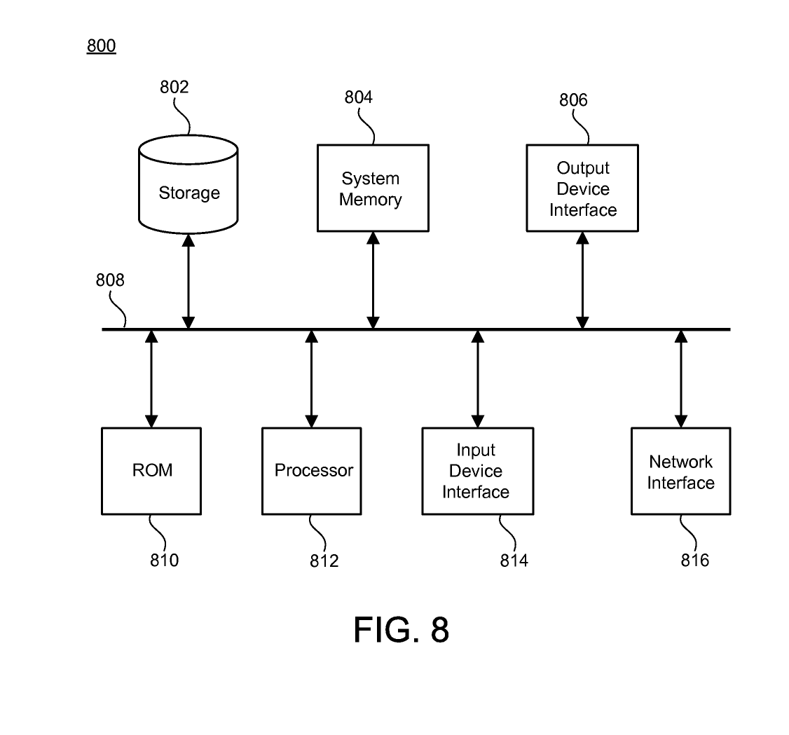

FIG. 8 conceptually illustrates an example electronic system with which some implementations of the subject technology can be implemented. Electronic system 800 can be a computer, phone, PDA, or any other sort of electronic device. Such an electronic system includes various types of computer readable media and interfaces for various other types of computer readable media. Electronic system 800 includes a bus 808, processing unit(s) 812, a system memory 804, a read-only memory (ROM) 810, a permanent storage device 802, an input device interface 814, an output device interface 806, and a network interface 816.

Bus 808 collectively represents all system, peripheral, and chipset buses that communicatively connect the numerous internal devices of electronic system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of the electronic system. Permanent storage device 802, on the other hand, is a read-and-write memory device. This device is a non-volatile memory unit that stores instructions and data even when electronic system 800 is off. Some implementations of the subject disclosure use a mass-storage device (for example, a magnetic or optical disk and its corresponding disk drive) as permanent storage device 802.

Other implementations use a removable storage device (for example, a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such a random access memory. System memory 804 stores some of the instructions and data that the processor needs at runtime. In some implementations, the processes of the subject disclosure are stored in system memory 804, permanent storage device 802, or ROM 810. For example, the various memory units include instructions for changing between input modes in accordance with some implementations. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the electronic system. Input devices used with input device interface 814 include, for example, alphanumeric keyboards and pointing devices (also called “cursor control devices”). Output device interfaces 806 enables, for example, the display of images generated by the electronic system 800. Output devices used with output device interface 806 include, for example, printers and display devices, for example, cathode ray tubes (CRT) or liquid crystal displays (LCD). Some implementations include devices, for example, a touchscreen that functions as both input and output devices.

Finally, as shown in FIG. 8, bus 808 also couples electronic system 800 to a network (not shown) through a network interface 816. In this manner, the computer can be a part of a network of computers (for example, a local area network (“LAN”), a wide area network (“WAN”), or an Intranet, or a network of networks, for example, the Internet. Any or all components of electronic system 800 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

1. A computer-implemented method for automatically changing between input modes based on user input, the method comprising:
receiving user input in association with a user interface element, the user input comprising an input type and an input gesture, the user interface element being a tabbed interface comprising plural tabs;
determining whether the input type is a first input type or a second input type;
in a case where the input type is the first input type,
determining that the input gesture is a first predetermined gesture, and
switching, in response to determining that the input gesture is the first predetermined gesture, the tabbed interface from a second input mode to a first input mode; and
in a case where the input type is the second input type,
determining that the input gesture is a second predetermined gesture, and
switching, in response to determining that the input gesture is the second predetermined gesture, the tabbed interface from the first input mode to the second input mode,
wherein when new tabs are added to the tabbed interface in the second input mode, the plural tabs of the tabbed interface are continuously shrunk until reaching a reset size, and after reaching the preset size a subset of the plural tabs are arranged in a stack, and wherein the tabs in the stack partially overlap each other and are displayed in-line with the remaining of the plural tabs.

2. The method of claim 1, wherein the first input type corresponds to mouse input, trackball input, pen input or stylus input.

3. The method of claim 1, wherein the second input type corresponds to touch input or trackpad input.

4. (canceled)

5. The method of claim 1, wherein the first predetermined gesture is movement into and out of the tabbed interface.

6. The method of claim 1, wherein the first predetermined gesture is selection of one tab from the plural tabs of the tabbed interface.

7. The method of claim 1, wherein the second predetermined gesture is selection of one tab from the plural tabs of the tabbed interface.

8. The method of claim 1, wherein the first input mode is a shrink mode in which the plural tabs of the tabbed interface are continuously shrunk when new tabs are added to the tabbed interface.

9. (canceled)

10. A system for automatically changing between input modes for a user interface, the system comprising:
one or more processors; and
a machine-readable medium comprising instructions stored therein, which when executed by the processors, cause the processors to perform operations comprising:
receiving user input in association with a user interface element of the user interface, the user input comprising an input type and an input gesture, the user interface element being a tabbed interface comprising plural tabs;
determining whether the input type is a first input type or a second input type;
in a case where the input type is the first input type,
determining that the input gesture is a first predetermined gesture, and
switching, in response to determining that the input gesture is the first predetermined gesture, the tabbed interface from a second input mode to a first input mode; and
in a case where the input type is the second input type,
determining that the input gesture is a second predetermined gesture, and
switching, in response to determining that the input gesture is the second predetermined gesture, the tabbed interface from the first input mode to the second input mode,
wherein when new tabs are added to the tabbed interface in the second input mode, the plural tabs of the tabbed interface are continuously shrunk until reaching a preset size, and after reaching the preset size, a subset of the plural tabs are arranged in a stack, and wherein the tabs in the stack partially overlap each other and are displayed in-line with the remaining of the plural tabs.

11. The system of claim 10, wherein the first input type corresponds to mouse input, trackball input, pen input or stylus input.

12. The system of claim 10, wherein the second input type corresponds to touch input or trackpad input.

13. (canceled)

14. The system of claim 10, wherein the first predetermined gesture is movement into and out of the tabbed interface.

15. The system of claim 10, wherein the first predetermined gesture is selection of one tab from the plural tabs of the tabbed interface.

16. The system of claim 10, wherein the second predetermined gesture is selection of one tab from the plural tabs of the tabbed interface.

17. The system of claim 10, wherein the first input mode is a shrink mode in which the plural tabs of the tabbed interface are continuously shrunk when new tabs are added to the tabbed interface.

18. (canceled)

19. A machine-readable medium comprising instructions stored therein, which when executed by a system, cause the system to perform operations comprising:
receiving user input in association with a user interface element, the user input comprising an input type and an input gesture, the user interface element being a tabbed interface comprising plural tabs;
determining that the input type is a first input type;
determining, in response to determining that the input type is the first input type, that the input gesture is a predetermined gesture, and
switching, in response to determining that the input gesture is the predetermined gesture, the tabbed interface from a second input mode to a first input mode, the second input mode being a stack mode, wherein when new tabs are added to the tabbed interface in the stack mode, the plural tabs of the tabbed interface are continuously shrunk until reaching a preset size, and after reaching the preset size, a subset of the plural tabs are arranged in a stack, and wherein the tabs in the stack partially overlap each other and are displayed in-line with the remaining of the plural tabs.

20. The machine-readable medium of claim 19, wherein the first input type corresponds to mouse input, trackball input, pen input, stylus input, touch input or trackpad input.

21. The method of claim 1, wherein the second predetermined gesture comprises receiving selection of one tab from the plural tabs of the tabbed interface via a cursor, and
wherein the switching the tabbed interface from the first input mode to the second input mode comprises changing a position of the selected tab to a new position in-line with other tabs from the plural tabs of the tabbed interface, and positioning the cursor to overlay the selected tab at the new position.

22. The method of claim 1, wherein the first predetermined gesture is one of movement into and out of the tabbed interface or selection of one tab from the plural tabs of the tabbed interface,
wherein the second predetermined gesture is selection of one tab from the plural tabs of the tabbed interface, and
wherein the first input mode is a shrink mode in which the plural tabs of the tabbed interface are continuously shrunk when new tabs are added to the tabbed interface.

23. The method of claim 1, wherein the switching the tabbed interface from the first input mode to the second input mode comprises changing the size of a tab from the plural tabs of the tabbed interface.
